(19) United States
(12) Patent Application Publication
(10) Pub. No.: US 2023/0142623 A1
(43) Pub. Date: May 11, 2023

(54) QUANTUM SYSTEM AND UNDESIRED INTERACTION PREVENTION MECHANISM THEREFORE

(71) Applicant: SOCPRA SCIENCES ET GENIE S.E.C., Sherbrooke (CA)

(72) Inventors: Catherine LEROUX, Sherbrooke (CA); Agustin DI PAOLO, Sherbrooke (CA); Alexandre BLAIS, Sherbrooke (CA)

(21) Appl. No.: 17/673,259

(22) Filed: Feb. 16, 2022

Related U.S. Application Data
(60) Provisional application No. 63/151,170, filed on Feb. 19, 2021.

(51) Int. Cl. G06N 10/20; G06F 15/82

(52) U.S. Cl. CPC G06N 10/20; G06F 15/82

(57) ABSTRACT

The generally quantum system can have : a first quantum subsystem having a first set of eigenstates; a second quantum subsystem having a second set of eigenstates; a coupler connected to both the first quantum system and to the second quantum system, the coupler having a third set of eigenstates; at least one interaction drive configured to control interaction between the first set of eigenstates and the second set of eigenstates via transitions within the third set of eigenstates; an auxiliary quantum subsystem connected to the coupler; and an attenuation drive selectively operable at a drive amplitude to generate a set of stabilized states in the auxiliary quantum system, said set of stabilized states being entangled with the third set of eigenstates in a manner that the probability of said transition within the third set of eigenstates is set by a probability of transition in the set of stabilized states.

### BACKGROUND

Quantum systems have received significant research and development interest and activity in the last years and are expected to become more and more mainstream within the next decades. A lot of this new interest is tied to the immense potential of the technology, in particular in relation with quantum computing and computer/communication security, but also in relation with other significant areas of interest. Many quantum systems use two or more quantum subsystems interconnected by a coupler, and many of the latter type of quantum system can be scaled by adding additional couplers and quantum subsystems, which is the case, for instance, in gate-based quantum computers where the quantum subsystems are qbits each having two eigenstates. Other applications of the latter type of quantum system can be a quantum communications router, for instance, where the quantum subsystems can have more than two eigenstates, for instance.

The exact nature of the quantum subsystems and of the couplers will vary depending on the type of quantum architectures in which they are implemented. Various architectures have been developed in recent years, such as superconducting circuits, trapped ions, photonic, etc. The general idea, irrespective of the architecture, and specific application, is to generate a quantum interaction such as entanglement or disentanglement between the eigenstates of the coupled quantum subsystems in a controlled manner, which can be done using one or more drive and via the eigenstates of the coupler. The drive(s) can be connected to the coupler or to the quantum subsystem(s). Although a coupler is often referred to as a “bus” when the drive(s) is not connected to it, we will refer to this latter configuration as “coupler” herein as well, for the sake of simplicity. Quantum interaction control can implicitly involve two aspects, or facets : stimulating the interaction on demand, and avoiding undesired interactions from spontaneously occurring due to quantum effects.

Depending on the architecture, it can be easier, or harder, to stimulate the controlled quantum interaction, and in architectures where stimulating the controlled quantum interaction is easier, the question of avoiding undesired interaction is typically more challenging.

This can be the case in the context of superconducting architectures, for instance, where much research and development effort has been placed in recent years in an effort to allow precisely controlling the drives, e.g. turning them on and then turning them off quickly, in a manner to favor on-demand interactions while avoiding undesired interactions. While these techniques have been satisfactory to a certain degree, there still remains room for improvement. For instance, there remained two major difficulties that limit the performance of tunable-coupler-based superconducting architectures. Firstly, while a tunable coupler was designed to activate on-demand interactions between two quantum systems, certain spurious couplings might still be present when the coupler is turned to its ‘off’ position. An example of these interactions is the always-on spurious cross-Kerr or ZZ coupling, which is ubiquitous in superconducting circuits. Moreover, despite being in the ‘off’ position, the coupler does not prevent delocalisation of the qubits’ wavefunctions in the processor, responsible for cross-talk. Secondly, the on-off ratio of the coupler is first-order sensitive to a control parameter, such as an external flux. While first-order sensitivity to a control parameter is practical to achieve fast tunability of the coupler, noise in the control can limit the coupler on-off ratio and therefore introduce qubit errors. A frequency-fixed bus does not suffer from the latter, but the lack of tunability prevents the active reduction of the cross-talk errors during idle times.

### SUMMARY

As presented in greater detail in the following specification using an additional quantum system, referred to herein as an auxiliary quantum system, and an associated drive, referred to herein as an attenuation drive, is proposed as a means of reducing the probability of undesired interaction. More specifically, the auxiliary quantum system is used to host stabilized states generated by the attenuation drive, and is connected to the coupler via a longitudinal-like interaction (an example detailed further below presents a cross-Kerr in situ interaction which, although not technically being a longitudinal interaction, exhibits longitudinal interaction dynamics), in a manner for the stabilized states to become entangled with the eigenstates. Due to the entanglement, the probability of transition of the eigenstates of the coupler is set by a probability of transition in the set of stabilized states, and can reduce exponentially as a function of an increase in the attenuation drive amplitude.

In superconducting architectures, this can be achieve by embodying the auxiliary quantum subsystem and the coupler as a circuit element having a three-node superconducting loop involving two Josephson junctions in parallel, and an inductance. Such a circuit can exhibit a cross-Kerr in situ interaction which can be harnessed in this context. Alternately, a similar circuit can be harnessed for other applications where such longitudinal-like interaction is beneficial, such as readout.

In accordance with one aspect, there is provided a quantum system comprising : a first quantum subsystem having a first set of eigenstates; a second quantum subsystem having a second set of eigenstates; a coupler connected to both the first quantum system and to the second quantum system, the coupler having a third set of eigenstates; at least one interaction drive associated to a respective one of the first quantum subsystem, the second quantum subsystem and the coupler, the at least one interaction drive configured to control interaction between the first set of eigenstates and the second set of eigenstates via transitions within the third set of eigenstates; an auxiliary quantum subsystem connected to the coupler; and an attenuation drive selectively operable at a drive amplitude to generate a set of stabilized states in the auxiliary quantum system, said set of stabilized states being entangled with the third set of eigenstates.

In accordance with another aspect, there is provided a method of operating a quantum system comprising : using an interaction drive, controlling the eigenstates of at least one a first quantum subsystem, a second quantum subsystem, and a coupler, to stimulate a quantum interaction between the first quantum subsystem and the second quantum subsystem; and, subsequently using an attenuation drive, generating a set of stabilized states in an auxiliary quantum subsystem, and entangling the set of stabilized states of the auxiliary quantum subsystems with the eigenstates of the coupler to impede quantum interactions between the first and second quantum subsystems via the coupler.

In accordance with a further aspect, there is provided a quantum system comprising : a first quantum subsystem having a first set of eigenstates; a second quantum subsystem having a second set of eigenstates; a coupler connected to both the first quantum system and to the second quantum system, the coupler having a third set of eigenstates; at least one interaction drive configured to control interaction between the first set of eigenstates and the second set of eigenstates via transitions within the third set of eigenstates; an auxiliary quantum subsystem connected to the coupler; and an attenuation drive selectively operable at a drive amplitude to generate a set of stabilized states in the auxiliary quantum system, said set of stabilized states being entangled with the third set of eigenstates in a manner that the probability of said transition within the third set of eigenstates is set by a probability of transition in the set of stabilized states.

Many further features and combinations thereof concerning the present improvements will appear to those skilled in the art following a reading of the instant disclosure.

### DESCRIPTION OF THE FIGURES

In the figures,

FIG. 1A is a schematic view of a quantum system in accordance with one example, FIGS. 1B and 1C presenting variants thereof;

FIGS. 2A and 2B is a schematic view of the operation of the coupler in an “ON” state, and in an “OFF” state, respectively, on the quantum transitions in the eigenstates of the components of FIG. 1A;

FIGS. 3A to 3C present alternate embodiments using more than one auxiliary quantum subsystem;

FIGS. 4A and 4B schematically illustrate the disjoining of the coupler eigenstates exponentially reducing the transition probability;

FIG. 5A-8 graphically represent the behavior of different models in the phase space as a function of attenuation drive amplitude;

FIG. 9 a) Schematic representation of the proposal. Q₁ and Q₂ are two qubits capacitively coupled to C. a coupler or bus. The coupler is connected to a resonator R through a cross-Kerr type interaction. In the ‘on’ state, the drive in the resonator is turned off and the setup reduces to a standard architecture for two-qubit gates mediated by the coupler. In contrast, in the ‘off’ state, the resonator is driven in a way that reduces the effective interaction between the qubits;

FIG. 9 b) Possible implementation in a superconducting circuit. The three-node loop implements the strong cross-Kerr interaction between the coupler and the lumped element resonator. The 180° hybrid divider ensures that the voltage drive V(t) is applied to the resonator only;

FIG. 9 c) We show the truncated Wigner function in the resonator of the partially traced stabilized polaronic states for fixed eigenstate of the coupler and different α₀s;

FIGS. 10 a) and b) show a numerical experiment: fitted Rabi frequency Ω̅̅̅/2π and dephasing time T̅̅_{φ}, respectively, of the coupler under a resonant Ω̅/2π= 1 MHz microwave drive as a function of the photon number in the resonator, |α₀|², using a 5 ns TQD scheme with k/2π = 100 KHz, δ/2π = -5 MHz, αₓ/2π = -300 MHz, and different cross-Kerr interaction strengths –30.0 ≤ χ/2π ≤ -5.0 MHz. Fits are done by comparing the time-evolution to that of an effective two-level system, including both T₁ and T₂. We indeed find that the resonator does not affect T₁ in the ideal model. Black lines correspond to Eqs. 6 and 8;

FIG. 10 c) shows an example of the time-evolution traces of the numerial experiment of FIGS. 10 a) and 10 b) for a polaronic state size of |α₀(T)|² = 0,

FIG. 10 d) shows another example of the time-evolution traces of the numerial experiment of FIGS. 10 a) and 10 b) for a polaronic state size of |α₀(T)|² = 4;

FIG. 10 e) shows another example of the time-evolution traces of the numerial experiment of FIGS. 10 a) and 10 b) for a polaronic state size of |α₀(T)|² = 16;

FIGS. 11 a) and b) show a numerical experiment: fitted dispersive shift |δ|₁/2π and dephasing time T̅φ|v , respectively, as a function of the photon number in the resonator, |α₀|². Here (ω₁ - ω_{c})/2π = 20 MHz, α₁/2π = -300 MHz and g₁/2π = 3 MHz. See FIG. 10 for missing parameters. Fits are done by comparing the time-evolution to that of an effective two-level system. We indeed find that the resonator does not affect T₁ in the ideal model. Black lines correspond to Eq. 9;

FIG. 12 a) shows a numerical experiment: fitted SWAP rate |J|/2π as a function of the photon number in the resonator, |α₀|². Here (ωᵥ - ω_{c})/2π= 15 MHz, α_{w}/2π = α_{c}/2π = -300 MHz and gᵥ/2π = 3 MHz. See FIG. 10 for missing parameters. Fits are done by comparing the excitation number in Q₂ to a model Asin²(Jt)e^{-y2} with free parameters A,γ. Black lines in a) correspond to 15;

FIG. 12 b) shows an example of the time-evolution traces of the numerical experiment of FIG. 12 a) for a polaronic state size of |α₀(T)|² = 0,

FIG. 12 c) shows another example of the time-evolution traces of the numerical experiment of FIG. 12 a) for a polaronic state size of |α₀(T)|² = 13 ;

FIGS. 13 a) to d) Numerical experiment: fitted cross-Kerr |x₁₂|/2π for harmonic modes Q₁ₓ Q₂, αᵥ/2π = α_{c}/2π = -300 MHz, α₁/2π = -300 MHz, α₂/2π = -400 MHz, α_{c/}2π = -500 MHz, and α₁/2π = -400 MHz, α_{2/}2π = -300 MHz, α_{c}/2π = -500 MHz, respectively, as a function of the photon number in the resonator, |α₀(T)|². Here (ω₁ -ω_{c})/2π = 15 MHz, (ω₂ - ω₂)/2π = 30 MHz and gᵥ,/2π = 3 MHz. See FIG. 10 for missing parameters. Fits are done by comparing the time-evolution traces to a model Aœos(ωt+ ϕ)e^{-yt} with free parameters A, ϕ, γ;

FIGS. 14 a) to 14 f) represent example variants of circuits; and

FIG. 15 represents another example variant of a circuit.

### DETAILED DESCRIPTION

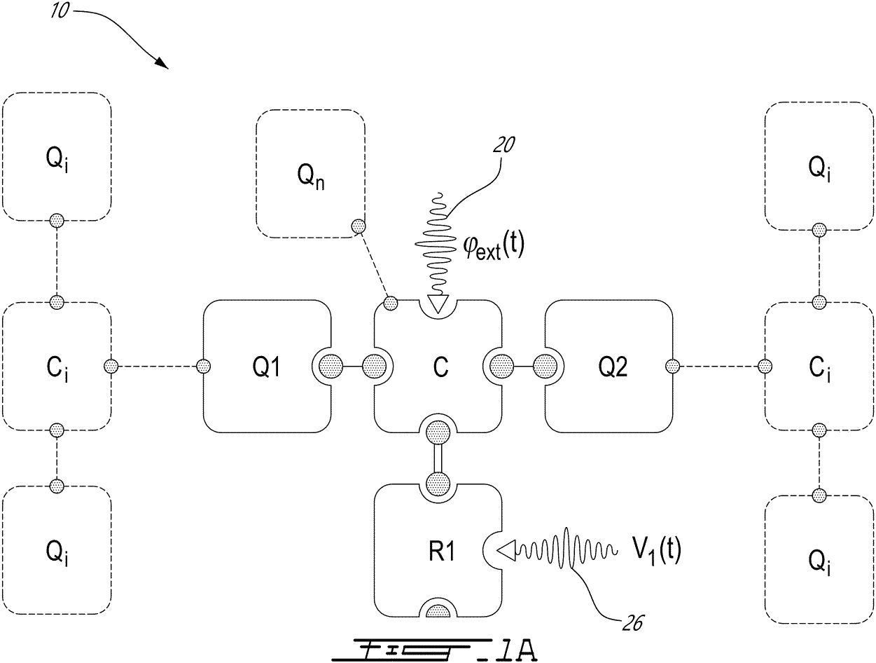

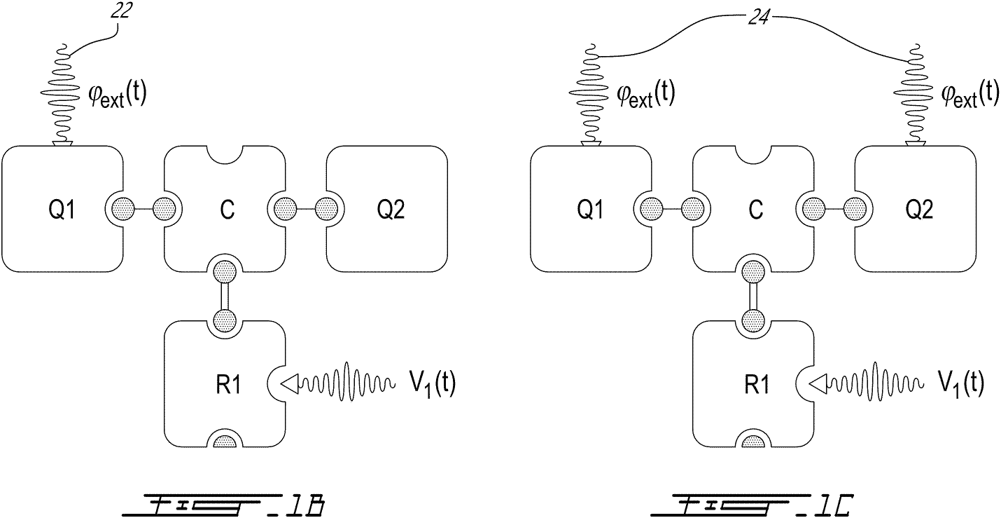

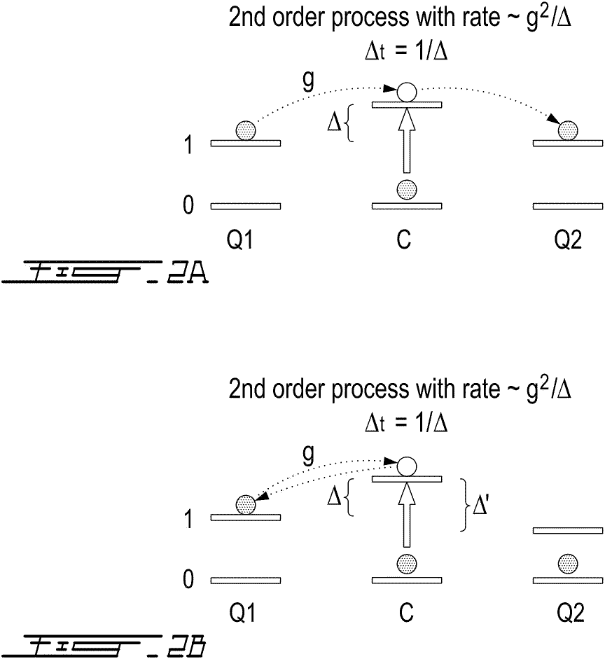

FIG. 1A shows an example of a quantum system 10 having a first quantum subsystem Q1, a second quantum subsystem Q2, and potentially more quantum subsystems QN, interconnected to one another via a coupler C in a manner for the eigenstates of the quantum subsystems Q1, Q2, QN to interact with one another via the eigenstates of the coupler C. The interaction is controlled by one or more drives which will be referred to herein as interaction drives. In this embodiment, an interaction drive 20 is used in association with the coupler C, but other configurations are possible in alternate embodiments, examples of which are presented in FIG. 1B, where a drive 22 is used in association with one of the quantum subsystems Q1 and FIG. 1C where interaction drives 24 are used in association with two quantum subsystems Q1, Q2. The one or more drives are typically connected to a controller, and it is typical for the controller to include a classical computer (not shown). It will be understood that the first quantum subsystem Q1, second quantum subsystem Q2, and coupler C can be part of a larger network of quantum system 10 elements having other quantum subsystems Qi interconnected by other couplers Ci, or not. We can focus here on the former components while still providing an exhaustive explanation. For ease of later reference, the eigenstates of the first quantum subsystem Q1 will be referred to herein as the first set of eigenstates, the eigenstates of the second quantum subsystem Q2 will be referred to herein as the second set of eigenstates, and the eigenstates of the coupler C will be referred to as the third set of eigenstates. FIGS. 2A and 2B schematically represent the two first, or two only, eigenstates of the first quantum subsystem Q1, of the second quantum subsystem Q2, and of the coupler C. FIG. 2A presents a scenario where the interaction drive(s) 22 is controlled to a state which can be referred to herein as the “ON” state, where the interaction is stimulated. FIG. 2B presents a scenario where the interaction drive(s) 24 is controlled to a state which can be referred to herein as the “OFF” state, where interactions are undesired.

Typically the interaction drive(s) is precisely controlled to trigger interactions between the eigenstates of Q1 and Q2 when desired. In a somewhat simplified way, in one example embodiment which is illustrated in FIG. 2A, this can correspond to changing the state from a first state where the difference of energy between the relevant eigenstates of Q1 and the coupler C is smaller than the difference of energy between Q2 and the coupler C, to a second state where the difference Δ of energy is made the same between the relevant eigenstates of Q1 and the coupler C, and between Q2 and the coupler C. This can be referred to as controlling the tuning/detuning. The control of the tuning/detuning is typically linearly related to the amplitude of the interaction drive(s), meaning that the degree of instability of the coupler eigenstates is linearly related to the amplitude of the interaction drive.

In the “off” state of the device, where interactions between the two quantum systems should be suppressed, spurious interactions between the two quantum systems remain. The dominant spurious interactions are second (represented in FIG. 2B) and fourth order (not shown, but known to persons skilled in the art) in the coupling strength between the coupler and these quantum systems. In virtue of Heisenberg energy uncertainty principle, the coupler’s eigenstates can be virtually occupied for a time inversely proportional to the energy difference (or detuning) the system requires to reach this configuration. The probability of each virtual transition is thus set by the ratio between the coupling strength and this energy difference. Intuitively, it is therefore possible to reduce the strength of spurious interactions by 1) increasing these energy differences, 2) reduce the coupling strength on demand. There are also other techniques based on directly driving the quantum systems and/or coupler to cancel specific transitions, for instance dynamical decoupling and spin echo. The current system uses a completely different approach. Instead, the virtual transitions to higher coupler’s eigenstates are controlled by the separation of the coherent states in the auxiliary system. In the “on” state, the proposed system is effectively reduced to a set-up where the auxiliary system is not present. It is then possible to enable interactions between the two quantum systems.

Here, we are interested in the issue of interactions occurring between the eigenstates of the quantum subsystems (such as Q1 and Q2) via the eigenstates of the coupler C when such interactions are not desired, e.g. when the interaction drive is in the OFF state. Accordingly, even when the drive is controlled to the OFF state, a quantum interaction (e.g. entanglement, disentanglement, typically a resonant interaction) may spontaneously occur and represent a source of error. One approach to try to control this is to focus on the control of the interaction drive, and thus on the tuning/detuning. Such undesired quantum interactions can stem from the excitation within the quantum subsystems Q1, Q2 themselves, or be introduced by the interaction drive(s), the latter representing a potential door to outside the quantum system.

Referring back to FIG. 1 it will be noted that in this embodiment, the quantum system 10 has further been provided with an auxiliary quantum subsystem R1 and an associated attenuation drive 26. As will now be explained in further detail, these components can be used to provide an additional mechanism to block undesired interactions between the quantum subsystems Q1, Q2, QN via the coupler C. Moreover, in an embodiment, the effectiveness of this additional blocking mechanism can increase exponentially as a function of the attenuation drive 26 amplitude.

The auxiliary quantum subsystem R1 is another quantum subsystem which can partially or fully host states. It is used here more specifically to host a set of stabilized states which are to be entangled with the eigenstates of the coupler C. Due to the entanglement, the probability of transition of the eigenstates of the coupler becomes set by a probability of transition in the set of stabilized states. The probability of transition in the set of stabilized states are reduced exponentially as a function of an increase in attenuation drive 26 amplitude. The type of interaction dynamics considered between the auxiliary quantum subsystem R1 and the coupler C is a longitudinal interaction dynamics and it will be seen that in one embodiment presented in greater detail below, this can be achieved by a cross-Kerr in situ interaction. The attenuation drive 26 is the drive(s) which is used to generate the stabilised state(s) in the auxiliary quantum subsystem R1.

The use of the auxiliary quantum subsystem R1 and attenuation drive 26 to generate the entangled stabilized states leads to a situation where the probability of transition of the coupler eigenstates is reduced exponentially as a function of an increase of the attenuation drive 26 amplitude, leading potentially to a much greater amount of control of the probability of transition than what can be achieved by the linear relationship effect of the interaction drive amplitude. It can be considered as acting on “coupling strength” rather than “tuning/detuning”. Moreover, by acting directly onto the probability of transition of the coupler C eigenstates, as opposed to acting on coupling strength, the reduction in the probability of undesired interaction is independent from the source of undesired interaction. In other words, the mechanism can operate independently of whether the undesired interactions stem from the quantum subsystems Q1, Q2 themselves, irrespective of the order of the undesired interaction, or of whether the undesired interactions stem from the interaction drive(s) or its effect on the quantum subsystems Q1, Q2.

An interesting feature of this approach is that it does not preclude the simultaneous use of other undesired interaction blocking mechanisms. For instance, the use of the auxiliary quantum subsystem R1 and attenuation drive 26 to ultimately stabilize the eigenstates of the coupler C does not preclude simultaneously detuning, referred to above as using the interaction drive(s) in the OFF configuration. Moreover, it does not preclude simultaneously dynamically detuning with the interaction drive(s), a technique by which the difference between the relative energy levels of the eigenstates are minutely and quickly varied in addition to being maintained different between the coupler C and the different quantum subsystems Q1, Q2.

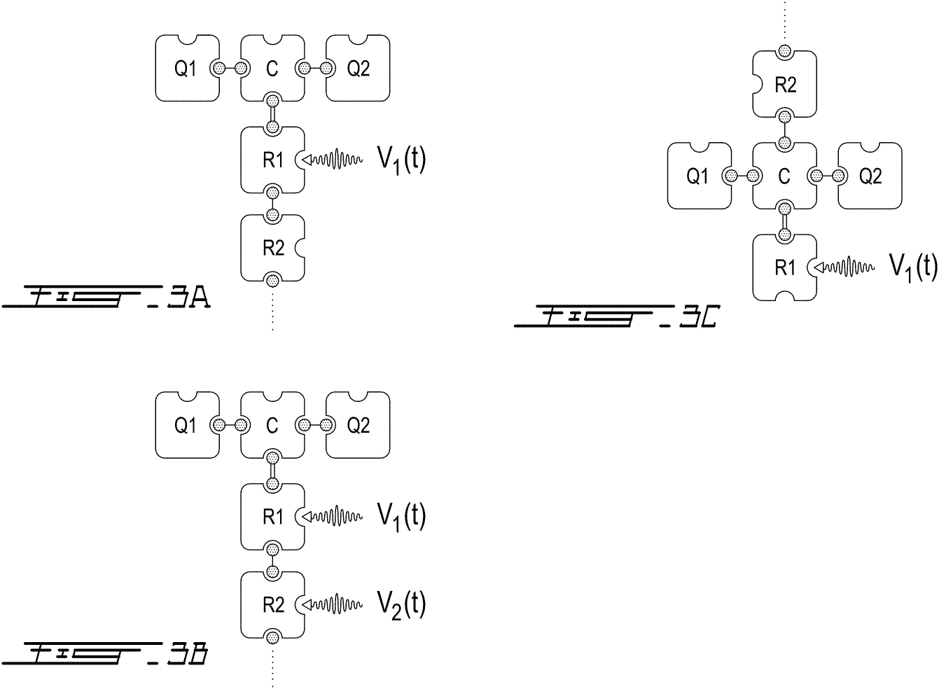

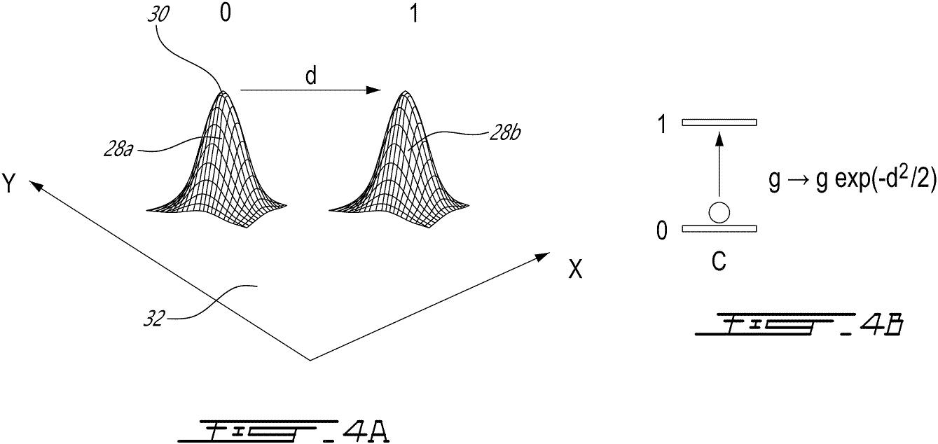

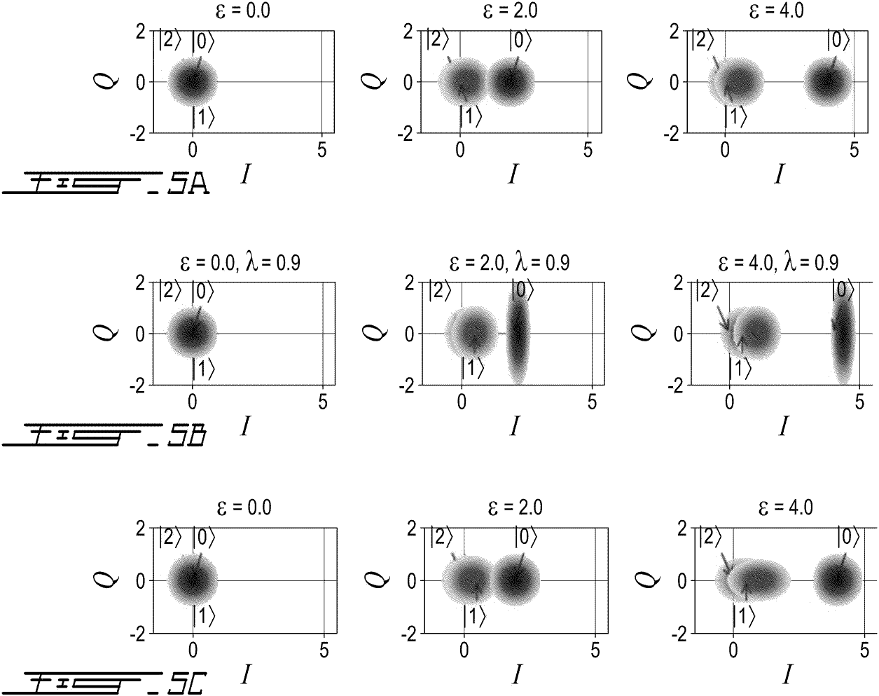

Moreover, another interesting feature of this approach is that it does not preclude the use of a second (or more) auxiliary quantum subsystems Ri (not shown) in which an attenuation drive (the first one or an additional, dedicated one) can generate a second set of stabilized states further entangled with the coupler eigenstates and the first set of stabilized states. In this manner, the probability of transition in the third set of eigenstates is further set by a probability of transition in the second (or additional) set of stabilized states. This approach can help in attenuating interactions which could otherwise occur via the first auxiliary quantum subsystem R1 for instance. A few possible configurations are presented in FIGS. 3A to 3C for the purposes of illustration.

As discussed above, the mechanism can be implemented in different applications and different quantum system architectures, and the exact hardware used to implement the quantum subsystems, the drives, and the coupler will depend on the choice of architecture. Example architectures and associated hardware elements will be discussed below. It will be understood that given the many different possible implementations, it is common when discussing quantum systems to discuss them at a somewhat higher degree of abstraction, and more specifically by using a Hamiltonian to represent the structure of the set of eigenstates. As known by persons skilled in the art, some Hamiltonians are more easily/naturally implemented in some architectures than others.

Similarly, the structure of the set of stabilized states (coherent states) to be generated in the auxiliary quantum subsystem can be represented by a Hamiltonian, and in some cases, by phase diagram representations. We will soon see by the presentation of a few examples, that various Hamiltonians can be used to achieved the on-demand highly disjoint support of the coupler’s eigenstates associated to the undesired interaction blocking mechanism discussed above.

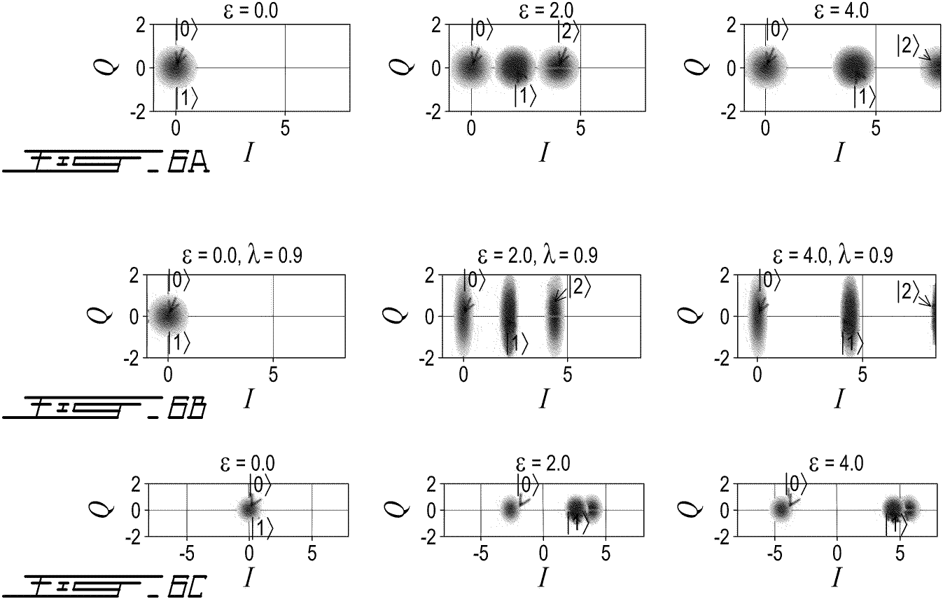

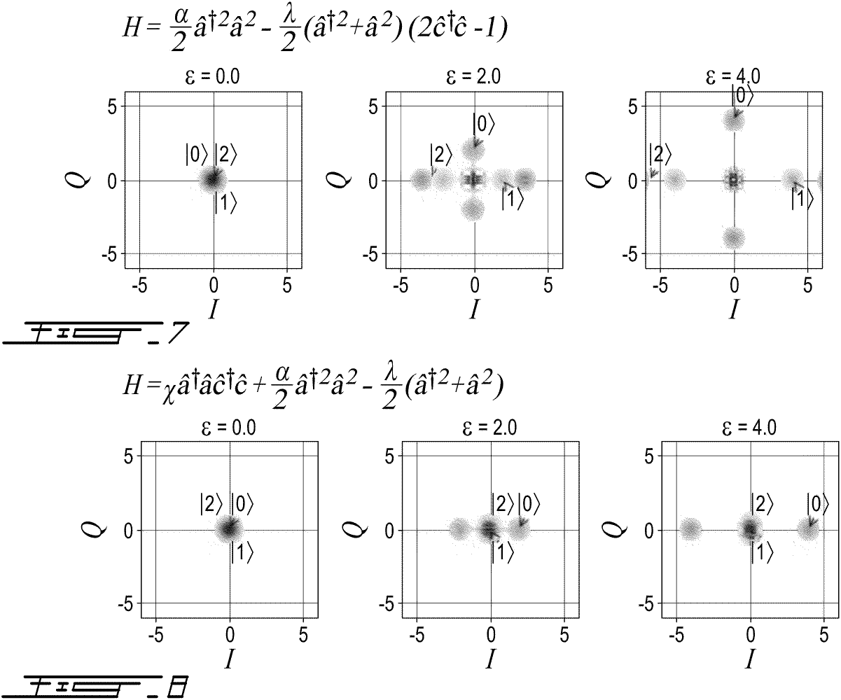

Generally, in at least some embodiments, the probability of transition within the eigenstates of the coupler can be normalized to 1 in the absence of an auxiliary quantum system/attenuation drive, and be considered to correspond to a superposition of quantum states or energy levels. Due to the inherent uncertainty associated to quantum states, the quantum states can be better represented as Gaussian curves 28a, 28b than by points, such as illustrated in FIG. 4A. A goal can be visualized as to separate the Gaussian curves 28a, 28b associated to the otherwise superposed states existing within the coupler in a manner to move the centers 30 of the corresponding Gaussian curves 28a, 28b away from one another in a plane normal to their amplitude, by a distance d. The distance d can be selected in a manner to allow clearly distinguishing the peaks 30 of the two Gaussian curves 28a, 28b, and preferably sufficient for the degree of curvature of the Gaussian curves to be considered sufficiently flat at the point of intersection, at which point they are considered disjoint. In any event, in this context, the probability of transition can decrease exponentially relative to the distance d, as illustrated at FIG. 4B, and the distance d can be related to the amplitude of the attenuation drive. In fact, since the effect of the attenuation drive with the Gaussian curves never completely dissociate the Gaussian curves from one another (it does, however, exponentially decrease with distance) it may be more appropriate to refer to approximate disjoint support of the coupler’s eigenstates, but we will use the expression “disjoint support of the coupler’s eigenstate” to cover this scenario herein for the purpose of simplicity.

In other words, the stabilized states of the auxiliary system can be illustrated in phase space analogously to classical mechanics. In classical mechanics, any one-dimensional system with a fixed position X and momentum Y can be represented by a point in the X-Y plane. In quantum mechanics, due to the Heisenberg uncertainty principle, this point becomes a Gaussian and is defined as a coherent state. In our system, each coupler’s eigenstate can be mapped to a Gaussian on X-Y plane 32. The attenuation drive determines the distance between the Gaussians. In our scheme, a transition between two coupler eigenstates can now happen only if there is overlap between the two Gaussians associated with the two involved coupler eigenstates. The further apart the Gaussians are, the smaller the overlap and the less likely the transition will occur. The overlap between the two Gaussians separated by a distance d is exp(-d^2/2), which sets the probability of the transition in the coupler and effectively renormalizes the coupling strengths with the quantum systems by the same amount.

In many embodiments, we can seek, by increasing the drive amplitude, to reach the portion of the Gaussian curve in which the probability diminishes exponentially relative to the distance between the peaks, i.e. outside the central portion, and ideally to a distance where the probability of transition, which is associated to the amount of overlap between the Gaussian curves of the different states, becomes negligible, however, in practical applications, it may also be desired to limit the amplitude of the attenuation drive to a certain extent, so an intermediary attenuation amplitude value corresponding to a tradeoff between limiting amplitude of attenuation drive and satisfactory attenuation can be desired.

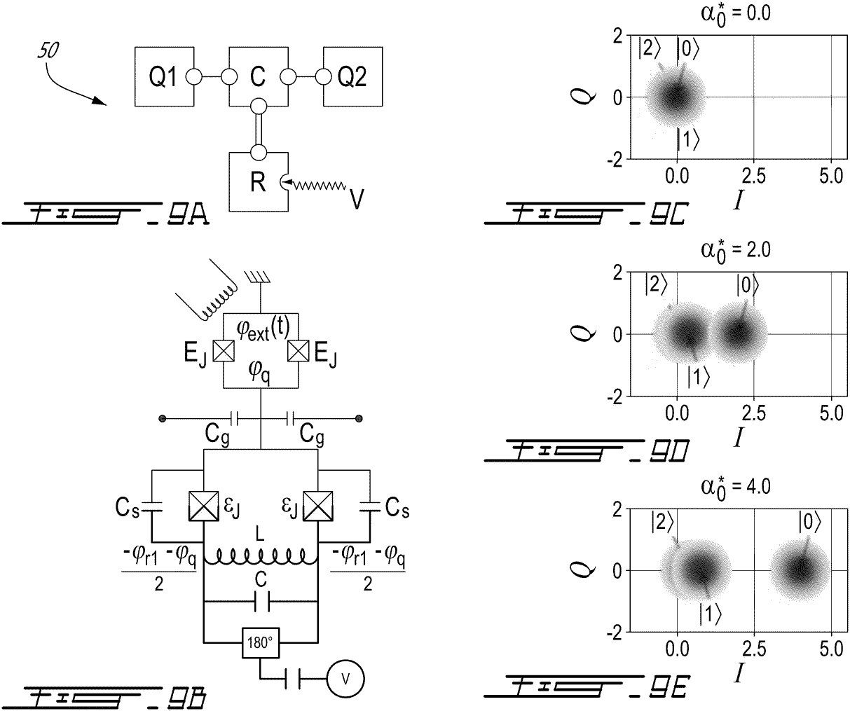

Several example models will now be presented, with reference to FIG. 5A-8. More specifically, each one of FIG. 5A to 8 presents three graphical representations of the Gaussian curves representative of the states. The graphical representation on the left-hand side represents the scenario where the attenuation drive is not activated, and where a set of stabilized states is thus not generated in the auxiliary drive, nor entangled with the eigenstates of the coupler. The Gaussian curves associated to different states are thus entirely overlapping and the probability of transition can be normalized to 1. The center and right-hand side graphs represent progressively increasing amplitude of the attenuation drive, and thus of the stabilized states. In all scenarios illustrated, it will be noted that the overlap between the Gaussian curves decreases as a function of increasing attenuation amplitude, and while the centers of the Gaussian curves move linearly relative to each other on the graph as a function of attenuation amplitude, the probability distribution of the Gaussian curves decreases exponentially, leading to an exponential decrease in transition probability as a function of attenuation amplitude, leading to the on-demand disjoint support of the coupler’s eigenstates functionality.

In the embodiment illustrated in FIG. 5A, the Hamiltonian can be expressed as H = δα̂^{†}α̂ + χα̂^{†}α̂ĉ^{†}ĉ - ∈ (α̂^{†} + α̂), , and the model can be referred to as a Cross-Kerr interaction and linear drive-based model. A detailed embodiment of this model will be presented further below.

The embodiment illustrated in FIG. 5B is represented by the Hamiltonian

$$H = δ {\hat{a}}^{†} \hat{a} + χ {\hat{a}}^{†} \hat{a} {\hat{c}}^{†} \hat{c} - e \left({\hat{a}}^{†} + \hat{a}\right) - \frac{λ}{2} \left({\hat{a}}^{† 2} + {\hat{a}}^{2}\right)$$

, and can be considered similar to the embodiment of FIG. 5A, to which a parametric drive was added.

The embodiment illustrated in FIG. 5C is represented by the Hamiltonian

$$H = δ {\hat{a}}^{†} \hat{a} + χ {\hat{a}}^{†} \hat{a} {\hat{c}}^{†} \hat{c} - e \left({\hat{a}}^{†} + \hat{a}\right) + \frac{a}{2} {\hat{a}}^{† 2} {\hat{a}}^{2} - \frac{λ}{2} \left({\hat{a}}^{† 2} + {\hat{a}}^{2}\right)$$

, and can be considered similar to the embodiment of FIG. 5B, to which Kerr interaction was added.

In the embodiment illustrated in FIG. 6A, the Hamiltonian can be expressed as H = δα̂^{†}α̂ - ∈ (α̂^{†} + â) ĉ^{†}ĉ , and the model can be referred to as longitudinal-interaction based.

The embodiment illustrated in FIG. 6B is represented by the Hamiltonian

$$H = δ {\hat{a}}^{†} \hat{a} - e \left({\hat{a}}^{†} + \hat{a}\right) {\hat{c}}^{†} \hat{c} - \frac{λ}{2} \left({\hat{a}}^{† 2} + {\hat{a}}^{2}\right)$$

, and can be considered similar to the embodiment of FIG. 6A, to which a parametric drive was added.

The embodiment illustrated in FIG. 6C is represented by the Hamiltonian

$$H = δ {\hat{a}}^{†} \hat{a} - e \left({\hat{a}}^{†} + \hat{a}\right) \left(2 {\hat{c}}^{†} \hat{c} - 1\right) + \frac{a}{2} {\hat{a}}^{† 2} {\hat{a}}^{2} - \frac{λ}{2} \left({\hat{a}}^{† 2} + {\hat{a}}^{2}\right)$$

, and can be considered similar to the embodiment of FIG. 6B, to which Kerr interaction was added.

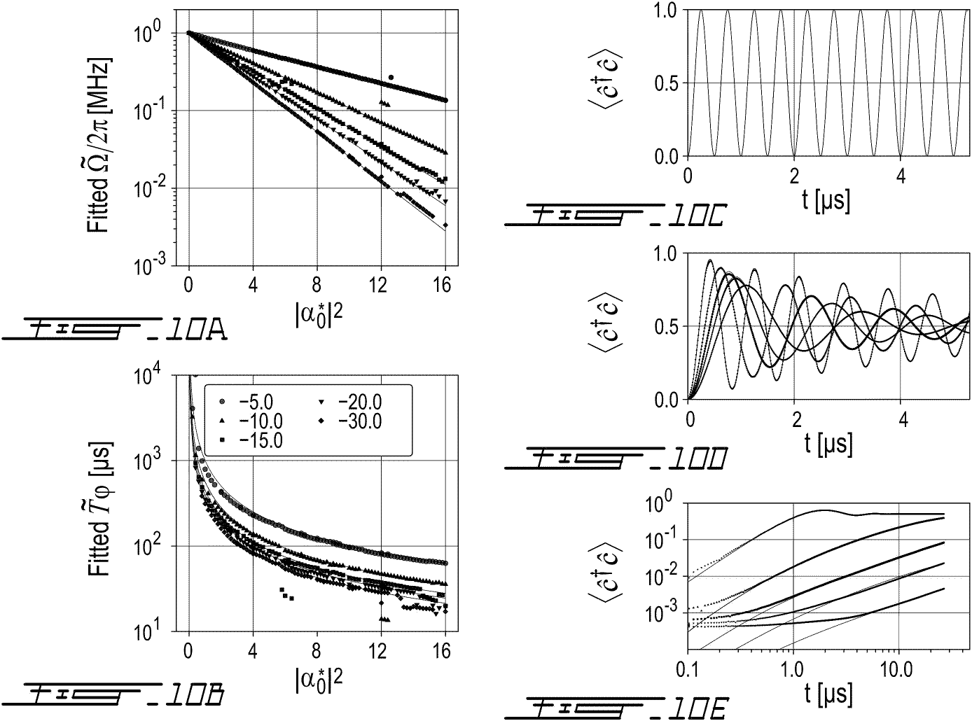

The embodiment illustrated in FIG. 7 is represented by the Hamiltonian

$$H = \frac{α}{2} {\hat{a}}^{† 2} {\hat{a}}^{2} - \frac{λ}{2} \left({\hat{α}}^{† 2} + {\hat{a}}^{2}\right) \left(2 {\hat{c}}^{†} \hat{c} - 1\right)$$

, and can be considered Kerr interaction and coupler-dependent parametric drive-based.

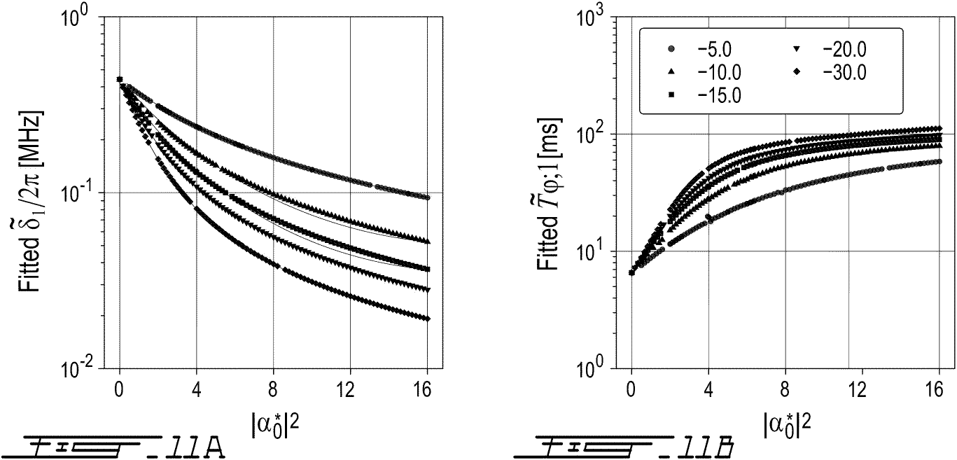

The embodiment illustrated in FIG. 8 is represented by the Hamiltonian

$$H = χ {\hat{a}}^{†} \hat{a} {\hat{c}}^{†} \hat{c} + \frac{α}{2} {\hat{a}}^{† 2} {\hat{a}}^{2} - \frac{λ}{2} \left({\hat{a}}^{† 2} + {\hat{a}}^{2}\right)$$

, and can be considered Cross-Kerr interaction, Kerr interaction and parametric drive based.

Other models are possible. Another model which will be referred to herein as the displaced inductively shunted transmon (DLT) model, will be presented below.

It will be noted right away that using the same approach, the addition of N auxiliary quantum subsystems can be roughly represented by the Hamiltonian : [0056]

$$\begin{matrix}H = {\sum }_{i = 1}^{N} {δ}_{i} {\hat{a}}_{i}^{†} {\hat{a}}_{i} - {\sum }_{i = 1}^{N - 1} {g}_{i} \left({\hat{a}}_{i}^{†} {\hat{a}}_{i + 1} + {\hat{a}}_{i + 1}^{†} {\hat{a}}_{i}\right) - e \left({\hat{a}}_{1}^{†} + {\hat{a}}_{1}\right) {\hat{c}}^{†} \hat{c} \\ \text{Stabilizes the polaronic states} \left|\frac{n e}{{δ}_{1}} , \frac{n e}{{δ}_{1}} \frac{{g}_{1}}{{δ}_{2}} , ⋯ , \frac{n e}{{δ}_{1}} {\prod }_{j = 1}^{N} \frac{{g}_{j}}{{δ}_{j}}\right〉 ⊗ \left|n\right〉\end{matrix}$$

As discussed above, many different architectures are possible in alternate embodiments. Indeed, the coupler can take different forms, such as : A. Superconducting qubits-like: frequency-fixed or flux-tunable transmon qubit circuit, generalized flux qubit circuit, or any type of protected qubit circuit; B. Semiconducting qubits-like, such as a gatemon circuit, or superconducting circuit where the Josephson junction is replaced by a 2DEG or a nanowire junction; C. Resonator mode; D. Optical cavity mode; E. Mechanical mode; F. Spin qubit; G. NV center; or H. Quantum dot.

The interactions presented in the models can be implemented in different ways depending on the type of quantum subsystem the coupler is, such as : A. Superconducting loops with Josephson junctions and inductances; B. Optomechanical (e.g. moving mirror mechanical mode in an optical cavity which acts a coupler); C. Nanomechanical (e.g. a NV center can couple longitudinally to the magnetic field gradient generated by an oscillating magnet).

A qbit is an example quantum subsystem which has only two eigenstates. Qbits can be present as the first and second quantum subsystems for instance, which would be typical to a quantum computer application where interactions are operations between the qbits. It would appear unlikely to that a qbit would be suitable for use as an auxiliary subsystem in many embodiments. A resonator is an example quantum subsystem which has an infinite number of eigenstates, which only depends of the energy available to excite them. A resonator can be a preferred choice for the auxiliary quantum subsystem in some embodiments.

The type of interaction between the quantum subsystems and the coupler will depend on the architecture of the particular embodiment. Using capacitive or inductive, Jaynes Cummings -type coupling would be typical in a superconducting circuit.

In many scenarios considered, the interaction via the coupler is virtual and due to Heisenberg energy uncertainty. But it is not excluded that some embodiments could use “occupied”, or stable states in the coupler.

Depending on the architecture, different avenues are available to achieve the control of the interaction between the first and second (or more) quantum subsystems. Typically, the difference of energy between the coupler eigenstates and the quantum system eigenstates makes the intermediary transition in the coupler unstable (virtual), due to Heisenberg uncertainty, and the excitation immediately transfers back to one of the quantum subsystems, and the goal of the control of the interaction drive(s) is to change the eigenstate configurations to facilitate or impede the interaction from one quantum subsystem to another. In some architectures, such as represented in FIG. 1A, a parametric drive can be used on the coupler to achieve this effect. In other architectures, a linear drive can be used on one, or both, quantum subsystems to achieve a comparable effect, such as illustrated in FIGS. 1B and 1C, respectively.

One of the particularities of quantum systems embodied in the superconducting circuit architecture is that interactions are typically very easy to achieve as opposed to in some other types of quantum architectures. Conversely, interactions more frequently occur when they are not desired. Therefore, issues associated to undesired interactions may be even more pronounced in some superconducting quantum architectures than in other types of architectures. Accordingly, we chose to set one example embodiment which will now be described in detail in the context of a superconducting circuit architecture.

### Detailed Description of an Example Embodiment

In this section, we thus focus on mitigating the undesired effects by proposing a coupler design where the transition matrix elements in the coupler are engineered to vanish exponentially in the strength of a control parameter. This key feature makes the coupler robust to external noise in the control and allows to realize an exponentially large on-off ratio. Importantly, the efficiency of our proposed scheme for a superconducting coupler or ‘switch’ is further determined by on-demand reduction of all coupler-mediated interactions, achieved by the decoupling of the involved quantum systems. More precisely, we engineer a two-mode device where the low-energy states are entangled states: the eigenstates of the bare coupler mode are projected onto distinct coherent states of an auxiliary cavity mode. The transition matrix elements of the coupler’s dipole operator are in this case renormalized by the probability of tunnelling between coherent states in the cavity, and are thus exponentially suppressed with the phase-space distance between them. The distance is controlled by the amplitude of a microwave drive applied to the cavity. Although not addressed in this letter, the overlaps between the cavity states can be further reduced by considering squeezing in the cavity via a parametric drive in the cavity. This decoupling mechanism is not operated, however, during two-qubit gates activation where other techniques can be used to suppress unwanted virtual interactions such as dynamical decoupling, interleaving positive and negative anharmonicities, and others.

Importantly, we highlight that the proposed device is a good complement for all-microwave frequency-fixed qubits architectures with interactions mediated by a bus. In this context, qubits are placed closer in resonance to increase two-qubit interactions with the price of larger two-qubit cross-talk. In our protocol, the coupling strengths to the bus are voltage-tunable and can be strongly suppressed on demand, even more strongly in this parameter regime. All virtual resonant multiqubit interactions mediated by the bus can be suppressed as well as the delocalization of the qubits’ wavefunctions in the processor. We emphasize that remove flux-tunability in the coupler has the advantage of higher coherence in the qubits. Nonetheless the protocol is also compatible tunable couplers used to activate parametric gates.

This section is organized as follows. First, we introduce the physical mechanism enabling the exponential suppression and present an ideal quantum-optics model that can implement it. Secondly, we report numerical results that demonstrate the exponential suppression of the transition rates in the coupler and discuss optimal parameter regimes for the device. Finally, we propose a superconducting implementation.

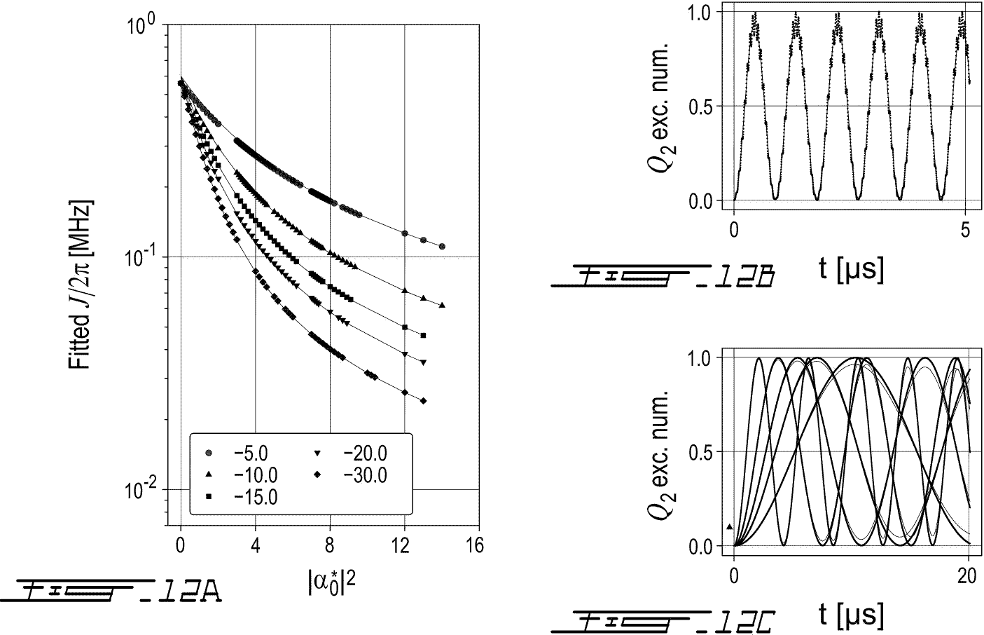

The system 50 that we consider is shown in FIG. 9 a), where two quantum modes Q₁ Q₂ are coupled by a coupler C represented by a bosonic mode. The coupler C is moreover coupled to a resonator R that is driven by a voltage source V. When R is not driven, the system 50 reduces to a standard circuit-QED setup where the coupler C can enable resonant Q₁-Q₂ interactions if tunable, or be used to mediate cross-resonance interactions. This operation condition defines the ‘on’ state of our setup. In contrast, by driving R, we entangle the coupler’s C eigenstates to coherent states in the auxiliary cavity mode. These states, also known as ‘polaronic states’, are the low-energy states stabilized by the proposed device and are illustrated in FIG. 9 c) in the phase space of the resonator. Importantly, the coherent states of R are approximately disjoint in phase space, and their overlaps is tunable by the drive field in R. In this context defined as the ‘off’ state of our system, a transition in the coupler is now assisted by a displacement (or a ‘tunneling’ event) between distinct cavity states, with its probability determined by their overlap. Transition rates in the coupler C can thus be made exponentially small as the distance grows between the cavity states.

In an unitarily equivalent frame, our device maps the coupler’s operator ĉ to the nonlinear form D̂(α)ĉ with ĉ (α̂) being the bosonic annihilation operator of the coupler (cavity) and D̂ (α) = e^{αα̂†-α*α̂}, the cavity displacement operator with amplitude α Fluctuations in the excitation number of the coupler are now accompanied by displacements of the cavity field. If the cavity is energetically constrained to Fock states of small photon number, tracing out the cavity results in the coupler’s operator being renormalized by the matrix elements of D̂(α) at small Fock states, proportional to e^{-|α|*/2}. Therefore, transitions between the coupler’s eigenstates are exponentially suppressed in |α|. In consequence, interactions enabled by virtual transitions in the coupler also result exponentially suppressed.

This design can be referred to as Switch Entangled to an Ancilla Longitudinally, or SEAL.

We emphasize that this scheme is not equivalent to using a protected qubit as a coupler. In fact, this does not directly guarantee an exponential suppression of virtual interactions as these are also mediated by unprotected levels. Transitions to these levels could be, ultimately, more energetically favorable especially in the case of a small-frequency protected qubit.

We will now discuss how to stabilize the polaronic states. We will omit the modes Q₁, Q₂ in the following discussion. Consider the Hamiltonian [0073]

$$\begin{matrix}{\hat{H}}_{s t a b} \left(t\right) = {ω}_{c} {\hat{c}}^{†} \hat{c} + \frac{α c}{2} {\hat{c}}^{† 2} {\hat{c}}^{2} + χ {\hat{c}}^{†} \hat{c} {\hat{a}}^{†} \hat{a} \\ + {ω}_{R} {\hat{a}}^{†} \hat{a} - ε \left(t\right) {e}^{- i {ω}_{D} t} {\hat{a}}^{†} - ε \text{*} \left(t\right) {e}^{i {ω}_{D} t} \hat{a} ,\end{matrix}$$

where ĉ (α̂) is the annihilation operator of the coupler (resonator) mode with frequency ω_{c} (ω_{R}), α_{c} is the coupler anharmonicity, χ is the cross-Kerr interaction strength between the coupler and the resonator and _{δ}(t) and ω_{D} = ω_{R} - δ are the time-dependent amplitude and frequency of the microwave drive applied to R. We also consider the resonator to be dissipative with decay rate _{K}. Analogously to the longitudinal readout scheme obtained through the dispersive Hamiltonian, the conjoint action of the the cross-Kerr interaction between _{C} and _{R} with the resonator drive leads to a displacement of the cavity mode which depend on the state of the _{C} mode.

We stress that there are other models to stabilize polaronic states such as one involving a direct modulated longitudinal interaction. However, this interaction is normally weak in superconductinng circuits such that we would require a small detuning from the cavity to grow large coherent states. This results in small energy gaps between the polaronic states, which is detrimental to efficiency of the proposed protocol.

The instantaneous eigenstates of Eq. 1 are the polaronic states |Ψ_{n,k})= |φₙ) ⊗|αₙ(t)e^{-Iωgt}k), where |Ψₙ) is the nth eigenstate of C and |αₙ(t), k) is the kth Fock state in R displaced by [0077]

$${α}_{n} \left(t\right) = \frac{\left(δ - i κ / 2\right) {α}_{0} \left(t\right)}{δ - i κ / 2 + n χ} ,$$

provided that ε(t) = (δ - ik/2)Z)α₀(t) where a₀(t) is a complex scalar function to be defined. We highlight that the larger the Fock state number is in |Ψₙₖ) the more the Wigner function of the cavity state spreads in phase space. Overlaps between the cavity states are more strongly suppressed for the k = 0 polaronic states. We therefore wish for the dynamics to be constrained in these states.

Importantly, the matrix elements of the transition operator T̋n,m = |ψₙ)(ψₘ| + |ψₘ)(ψₙ| in the coupler with respect to the stabilized polaronic states are proportional to the matrix elements of the cavity displacement operator D̂[αₘ - αₙ] with respect to Fock states, i.e. [0080]

$$\left|\left〈{Ψ}_{n , k} \vert {\hat{T}}_{n , m} \vert {Ψ}_{m , {k}^{′}}\right〉\right| = \left|\left(k \vert \hat{D} \left[{α}_{m} - {α}_{n}\right] \vert {k}^{′}\right)\right| .$$

By constraining the system dynamics to k = ₀ polaronic states we find that the transition rates in the coupler, [0082]

$$\left|\left〈{Ψ}_{n , 0} \vert {\hat{T}}_{n , m} \vert {Ψ}_{m , 0}\right〉\right| = {e}^{- {\left|{α}_{m} - {α}_{n}\right|}^{2} / 2} ,$$

are exponentially suppressed with respect to the displacement αₙ - αₘ of the cavity field.

We stress that the coupler is only virtually excited to mediate interactions, and therefore the transitions we ultimately wish to suppress on demand are 0 → n for any n. As can be seen from the equations above, αₙ(t) can be made large for n = 0 by choosing δ such that |δ/χ| is small. On the other hand, αₙ(t) for n ≠ 0 then has its amplitude suppressed in δ/χ. In this case, |αₙ - α₀| for n ≠ 0 can be made large thus enabling the exponential suppression of the 0 → n transition rate. The spatial separation of |ψ₀) from |ψ_{n≠0}) in the phase-space of the cavity is illustrated in FIG. 9 c).

To turn off the device we therefore need to adiabatically prepare the polaronic state |ψ_{0,0}) with large α₀, given that the coupler is constrained to its ground-state and the k = 0 polaronic states offer optimal suppression. This would be achieved by slowly and smoothly turning on ε(t). However, the rate for the adiabatic preparation is limited by δ which sets the energy gap with higher k polaronic states. Given |δ/χ| ≪ 1 and constraints on the size of χ, the model is thus complemented by a transitionless quantum driving (TQD) protocol of the cavity mode a in order to efficiently grow the intra-cavity field amplitude and be able to turn the coupler on and off rapidly. To this end we instead use the envelope

$$ε \left(t\right) = \left(δ - \frac{i x}{2}\right) {α}_{0} \left(t\right) - i {\dot{α}}_{0} \left(t\right) .$$

The Hamiltonian Equation 1 with the definition Eq. 5 can stabilize the polaronic states |Ψₙₖ) with the displacements provided that time-derivatives of α₀(t) have small amplitude compared to powers of |δ + nχ| for n ≠ 0 at both the beginning and the end of the switching on/off protocol.

We note that imprecision of equation 5 does not prevent the generation of displacement in the cavity, and doesn’t prevent the decoupling mechanism discussed in this work. However, when emptying the cavity to turn the device back in the ‘on’ state, they can leave a small excitation number _{N} in the cavity associated with a residual displacement of magnitude

$$\sqrt{N}$$

. Given the cross-Kerr interaction, this results in a renormalization of the coupler’s frequency by ~ χN. Along with the voltage pulse shaping precision, this sets a lower bound on the TQD protocol time. There are also other techniques available to help reset the cavity with greater precision.

The numerical studies that we present next are based on a TQD protocol that allows us to grow the |Ψ_{0,0}) state in T = 5 ns, realised at the beginning of each simulation. We chose α₀(t) to be a smooth real-valued step function with α₀(0) = 0, and α̂₀(t) = α̋₀(t) = 0 at t = 0 and t = T. For compactness we define α₀(T) = αᵣ.

We will now demonstrate that transition rates in the coupler can indeed be exponentially suppressed on demand by driving the resonator. To this end, our first numerical experiment consist of disconnecting Q₁ and Q₂ from the coupler and driving Rabi oscillations in C via a resonant linear drive of amplitude Ω directly applied in C. We emphasize that driving the resonator mode introduces AC-Stark shifts due to the cross-Kerr interaction in Equation 1, which are accounted for in the drive frequency.

The condition |Ω/δ| ≪ 1 is required here for the rotating wave approximation to hold such that the dynamics can be described by the k = 0 polaronic states. An effective single-mode Lindblad master equation for c can be derived. As advertised by Eq. 4, the Rabi frequency Ω is renormalized as [0092]

$$\tilde{Ω} ≃ Ω ⋅ exp \left(- {\left|β\right|}^{2} \text{} / \text{} 2\right) , \left(6\right)$$

$$β = {α}_{1} \left(T\right) - {α}_{0} \left(T\right) = - \frac{χ {α}_{0} \left(T\right)}{δ - i x / 2 + χ} ,$$

where the exponential suppression of the coupler bit-flip rate as a function of the resonator photon number |α₀(T)|² in the |Ψ_{0,0}) state emerges clearly. Here β is the displacement in the resonator associated with a 0 → ₁ transition in the coupler. Furthermore, the finite linewidth _{K} of the resonator renormalizes the coupler’s dephasing time T_{φ} as

$${\tilde{T}}_{φ} ≃ {\left({T}_{φ}^{- 1} + \frac{x}{2} ⋅ \frac{{\left|β\right|}^{2}}{2}\right)}^{- 1} ,$$

within a rotating wave approximation. The coupler-eigenstate-dependent displacement in the resonator results in lost photons carrying the which-state information about the coupler: this induces dephasing in the coupler.

We numerically compute Π and T_{φ} by fitting the time-evolution of (ĉ^{t}ĉ) for each

$${\left|{α}_{0}^{∗}\right|}^{2}$$

data point to the time-evolution of a two-level system under a Hamiltonian

$$\hat{H} = Δ {\hat{σ}}_{2} / 2 + Ω {\hat{σ}}_{χ}$$

= + with collapse operators

$$\sqrt{1 / {T}_{1}} \hat{σ} \text{} \_$$

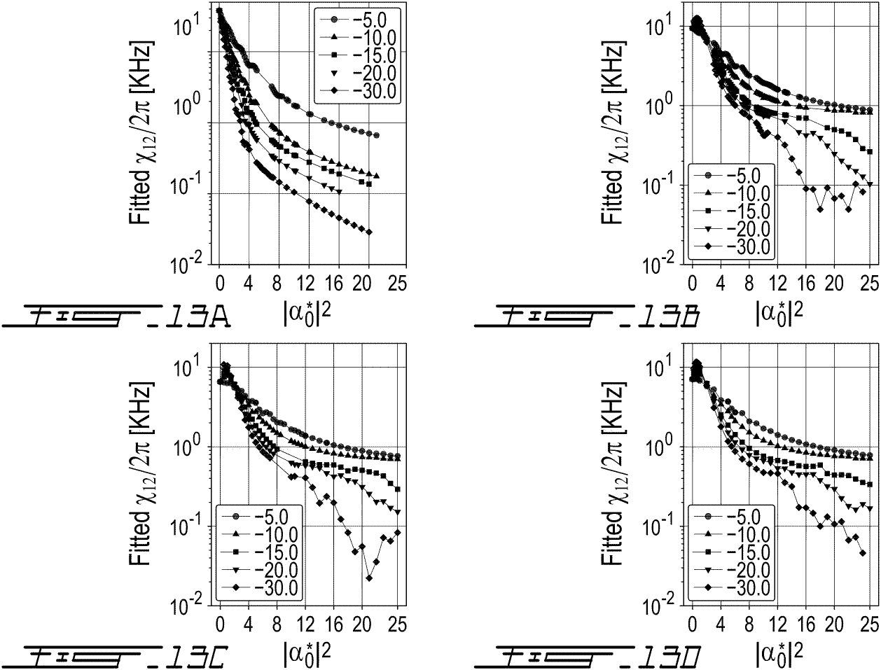

and

$$\sqrt{1 / {T}_{2}} {\hat{σ}}_{x}$$

where Δ, Π, T₁, T₂ are all free parameters. In the simulations, we ignore decoherence in the coupler due to its environment to isolate the effects of resonator dissipation on the system, i.e. T₂ = T_{φ} and as observed numerically, T₁ is not renormalized by the resonator. Both the exponential suppression of the bit-flip rate and the polynomial suppression of the coupler’s dephasing time significantly damp the Rabi oscillations, as shown in FIG. 10. We observe the larger coupler T_{φ} does not affect the performance of the proposed protocol.

We will now characterize the renormalization of the frequency ωₓ and coherence times of a system such as Q₁ coupled to C through a Jaynes-Cummings interaction with coupling strength gᵣ falling within the dispersive limit |gₓ/(ωₓ-ω_{c})|«1 due to both the drive and dissipation in _{R}.

From a Schrieffer-Wolff transformation, and after tracing out the coupler and resonator modes in the stabilized polaronic ground-state

$$\left|\left({Ψ}_{0 , 0}\right)\right) ,$$

we find that the dispersive shift in _{Q}, (with ᵥ = 1.2) to second order in the coupling strength is [symbol] where we defined the renormalized coupling strength

$${G}_{v} = {g}_{v} \sqrt{\frac{{e}^{- {\left|β\right|}^{2}} {\left(- {\left|β\right|}^{2}\right)}^{2 / {μ}_{v}} Γ \left[- 1 / {μ}_{v} , 0 , - {\left|β\right|}^{2}\right]}{- {μ}_{v}}} ,$$

where

$$Γ \left[a , {z}_{0} , {z}_{1}\right]$$

=

$${\int }_{{z}_{0}}^{{z}_{t}} {t}^{a - 1} {e}^{- t} d t$$

is the generalized incomplete gamma function,

$${Δ}_{v}^{A C} = {ω}_{v} - {ω}_{C} - \frac{δ \left(δ + X\right) - {\left(x / 2\right)}^{3}}{X} {\left|β\right|}^{2}$$

is the AC-stark shifted detuning between Qᵥ and C and finally

$${μ}_{v} = \frac{δ {+}_{X}}{{Δ}_{v}^{A C}} .$$

The parameter µᵥ in Eq. 12 determines how strong the suppression of Gᵥ is in lβ|². Physically, µᵥ is the ratio of two timescales: in virtue of the energy uncertainty principle, an excitation from Qᵥ can subsist virtually in C for a time

$$1 / \left|{Δ}_{v}^{\text{AC}}\right|$$

while the resonator can remain in the stabilized polaronic state

$$\left|ψ\right)$$

for a time x 1/|δ+χ| during a 0 →1 virtual transition in C, with a rate α |(Ψ_{1,4}|Ψ_{0,0})| set by the Fermi golden rule. Transitions from |Ψ_{0,0}) to [symbol] degrade the exponential suppression of the virtual interactions, since they have large overlaps. A larger µᵥ is associated with energetically unfavorable transitions to |Ψ_{1,k>0}) during a 0 → 1 transition in C.

Moreover, given that only T_{φ} is renormalized by the resonator dissipation in the current model (see Eq. 8), we find that only the dephasing time is also slightly renormalized in Qᵥ. The renormalization is fourth order in

$$g / {Δ}_{v}^{A C} .$$

Given the exponential suppression of the effective coupling strength we observe that the bare qubit dephasing time shouldn’t be limited by this renormalization, which is on the order of 10 s to 100 s of miliseconds for x = 100 KHz. We however note that direct coupling to the cavity would result in additional Purcell decay.

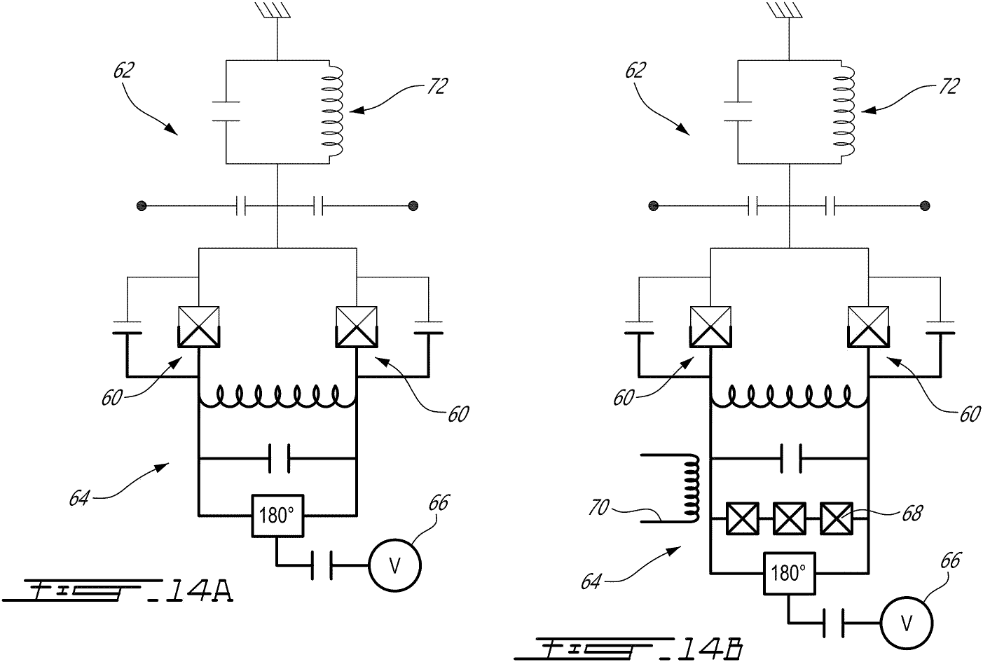

Omitting Q₂ to isolate the effects of C on Q₁ modelled as a Transmon qubit, we see strong quantative agreement with the dispersive shift in Eq. 9 in FIG. 11, where the induced dephasing time in Q₁ is also shown. These quantities were also obtained by fitting the time-evolution of the χ operator in

$${Q}_{1} ,$$

given

$${Q}_{1}$$

is initially prepared in |+〉 with that of an idealized two-level system. We considered the frequency, T₁ and T₂ as being free parameters as done in the previous section.

A couple of remarks about the parameter regime follow. To stay in the dispersive limit

$$\left|θ / {Δ}_{v}^{A C}\right| ≪$$

1 and avoid frequency collisions with higher displaced Fock states in the resonator, encoded in the constraints

$${μ}_{v} = - \frac{δ {+}_{X}}{{Δ}_{v}^{A C}} > 0 ,$$

$$\left|\frac{{g}^{2}}{\left({Δ}_{v}^{A C} + δ k\right) δ k}\right| ≪ 1 , k = 1 , 2 , ⋯ ,$$

we chose δ, χ such that the AC-stark shift in Eq. 11 helps grow

$${Δ}_{v}^{A C} \text{in}$$

magnitude with respect to |β|²: ωᵥ-ω_{c} >> |gᵥ|, while χ« -|gᵥ| and δ «

$$- \left|{g}_{v}^{2} / {Δ}_{v}^{A C}\right|$$

to reduce transitions to higher k polaronic states. Equation 12 arises from the condition |k(δ + χ) -

$$\left({Δ}_{v}^{A C}\right|$$

» 0 for any k such that transitioning to higher displaced Fock states in the resonator during a 0 → 1 transition in C is energetically unfavorable. On the other hand, Eq. 13 comes from suppressing the second order process 0 → 1 → 0 in C through the polaronic state |Ψ_{0,k}) with k ≠ 0.

We note that the growth of the AC-stark shift in |β|² also implies that µᵥ decreases in magnitude with respect to |β|², resulting in a slowdown in the suppression at large |β|² Nonetheless both the AC-stark shift’s growth and the disjoint support in the resonator contribute in suppressing virtual interactions mediated by the coupler.

Finally, it is worth mentioning that there exists poles in the gamma function in Eq. 10, and for very precise parameters Δₓ, δ, χ, k, |β|² it is possible to renormalize the coupling strength to zero in our idealized system. The physical mechanism responsible for this decoupling is however different from the one discussed in this work: virtual transitions to higher displaced Fock states now destructively interfere such as to decouple Qᵥ from C

An important feature of the device is the strong on-demand decoupling of the quantum systems interacting through the coupler mode. To illustrate this effect we now connect the two modes Q₁, Q₂ to the coupler C through a Jaynes-Cummings Hamiltonian with coupling strengths g₁, g₂ respectively that fall within the dispersive limit

$$\left|{g}_{v} / \left({ω}_{v}\right)\right)$$

-

$$\left(\left({ω}_{c}\right)\right|$$

« 1_{.} We further consider the case where Q₁, Q₂ are resonant such that the virtual SWAP interaction mediated by C is resonant. Our goal is to characterize the virtual SWAP rate

$${\text{against}}_{{a}_{o} \left(T\right)} .$$

We prepare Q₁ in |1) initially, turn on the TQD protocol and let the system evolve in time. By monitoring the frequency of oscillations in the excitation number of Q₂ we can fit the SWAP rate.

Using the same dispersive transformation as in the previous section, we find that the SWAP rate to second order in the coupling strengths is

$$J ≃ \frac{{G}_{Δ} {G}_{2} \left({Δ}_{1}^{A C} + {Δ}_{2}^{A C}\right)}{2 {Δ}_{1}^{A C} {Δ}_{2}^{A C}} .$$

There, we also imposed the additional parameter constraint

$$\left|\frac{{g}^{2}}{\left({Δ}_{v}^{A C} + δ k\right) \left({ω}_{\overline{v}} - {ω}_{v} + δ k\right)}\right| ≪ 1 , k = 1 , 2$$

for ᵥ = 1.2 and ᵥ ≠ v. Eq. 16 is akin to Eq. 14, but the 0 → 1 → 0 transition in C results in an exchange between Q₁ and Q₂.

We numerically compute the SWAP rate and obtain good quantitative agreement with Eq. 15. Despite Q₁ and Q₂ being on resonance, the device enables the exponential suppression of the coupling rates between Qᵥ and C. This illustrates the potential reduction of two-qubit cross-talk in a processor, especially in the context of strong local drives that can result in chaotic collective behavior. Moreover, this demonstrates that delocalization of qubits’ wavefunctions in a processor can be significantly reduced on demand.

We emphasize that in presence of noise in the coupler, if made tunable, the virtual SWAP rate will now be a weighted sum over terms such as in Eq. 15 with

$${Δ}_{v}^{A C}$$

→

$${\text{Δ}}_{v}^{A C}$$

- ω being shifted by the different harmonics ω, but is still proportional to G₁G₂. Importantly, the exponential suppression of the coupling strengths in Eq. 10 reduces the sensitivity to the external noise.

We however stress that direct interactions between Q₁, Q₂ and the resonator are not suppressed by this scheme. While these could be present in an experimental implementation of the model that we propose, a small interaction strength, typical of a stray coupling g_{stray}, combined with a resonator frequency that is largely detuned from Q₁, Q₂ will significantly reduce the impact of spurious terms which scales as

$${g}_{u n r e a d a b l e}^{2}$$

In the previous section we demonstrated a strong decoupling of the two systems Q₁, Q₂ through C, with exponentially reduced sensitivity to external noise in C as can be see from the renormalized coupling strengths in Eq. 10. An experimentally accessible metric for the cross-talk is the ZZ magnitude, a virtual cross-Kerr interaction between the modes Q₁, Q₂.

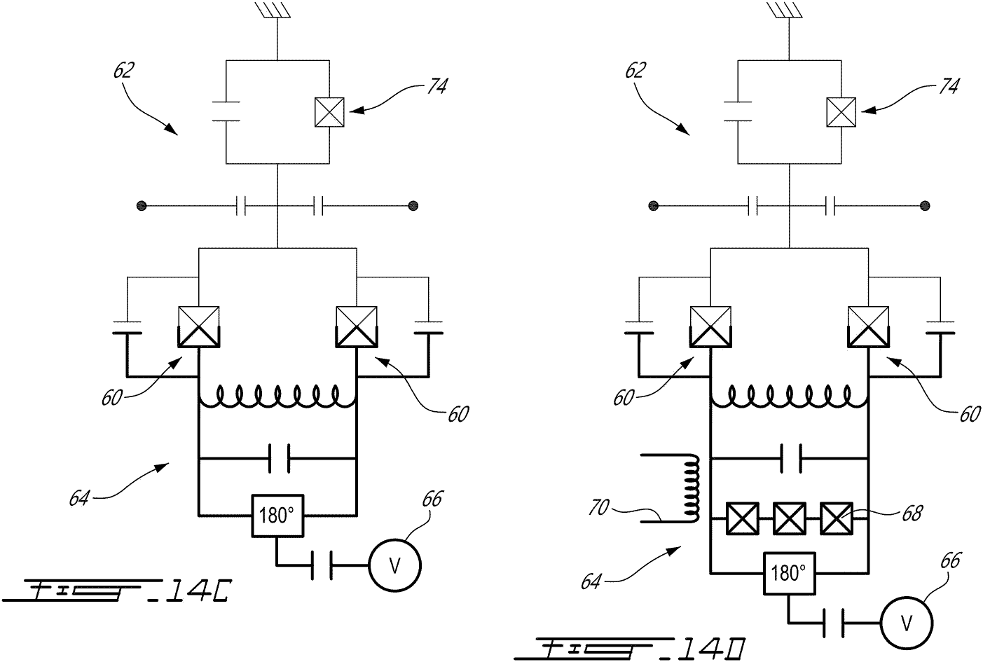

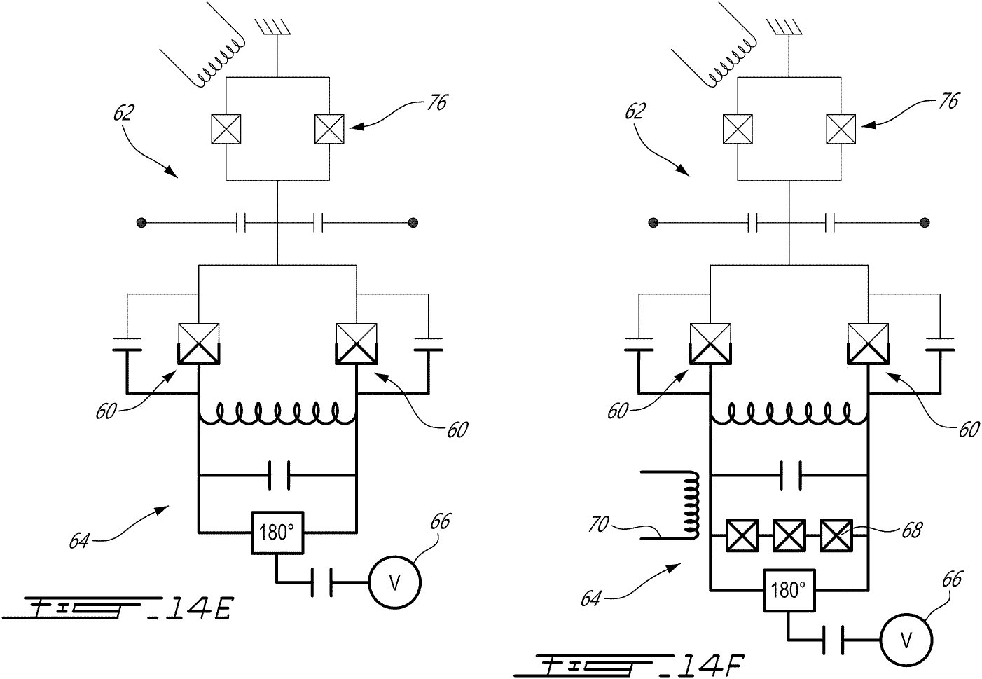

This quantity is computed by simulating the dynamics with Q₁ initially prepared in the |+) state and Qz, in |0) or |1) states while the other modes are their ground-states. We realize the TQD scheme and let the system evolve freely. The difference between between the oscillation frequencies of the expectation value of the χ operator in Q₁ for the two simulations corresponds to the cross-Kerr amplitude. We repeat the same numerical experiment with the roles of Q₁ and Q₁ interchanged, and take the average result as the cross-Kerr amplitude χ12 reported in FIG. 12.

Given the renormalization of the coupling strength in Eq. 10 we also observe exponentially suppressed amplitudes for these quantities. We note that independently of the magnitude of the detunings and anharmonicities of the modes, we obtain a strong suppression of the virtual interactions. Due to the complexity of the virtual processes contributing to the cross-Kerr interaction between Q₁ and Q₂ analytical estimates for the limiting cases of harmonic and anharmonic modes Q₁ and Q₂ can be found.

In a nutshell, the fourth-order virtual process χ₁₂ is a weighted sum over products of matrix elements of cavity displacement operators in Fock basis, which are also responsible for the suppression observed in Eq. 10. The weights are set by the Fermi golden rule and depend on the energy gaps between the stabilized polaronic states, while the displacement operators arise from transitions between these states. χ₁₂ can be ultimately separated in two main contributions: one involving only transitions between the ground and first excited state of the modes Q₁, Q₂, and one associated with transitions between the first and second excited state in these modes. The second contribution is strongly suppressed when the detunings |ωₓ-ω_{c}|/2π are much smaller than the modes’ anharmonicities |αₓ|/2π. This results in qualitatively different behaviors of χ₁₂ with respect to

$${\left|{a}_{0} \left(T\right)\right|}^{2}$$

in FIG. 12. We note that positive anharmonicity qubits could help prevent frequency collisions with k > 0 polaronic states with their second excited state. In any case, the limitation in the suppression of χ₁₂ is the transition to higher displaced Fock states in the resonator (i.e. k ≠ 0 polaronic states), a difficulty that could be potentially circumvented with the help of additional nonlinearity in the cavity such as to energetically constrain the dynamics in the k = 0 polaronic states.

For conciseness, and given that the coupler is only virtually excited, spurious cross-Kerr interactions between Qᵥ and C are not reported here but are equally exponentially suppressed. Indeed, the suppression mechanism introduced in this work directly targets the transition rates in C rather than trying to cancel specific transitions between the different involved systems by carefully designing the energy spectra of the involved systems. In consequence and unlike other architectures, any virtual process at any order in the coupling strengths involving any of the modes coupled directly to C (such as zzz), is suppressed by the mechanism presented.

It is worth mentioning that the targeted parameter regime here is based on the anharmonicities being much larger in magnitude than the detunings. Indeed, small detunings permit stronger suppressions of the effective coupling strengths as seen in Eq. 10, and larger anharmonicities help suppress the 1 → 2 transition in C. It is a convenient regime for frequency-fixed qubits such that a two-qubit cross-resonance (or CNOT) gate mediated by C and based on mircrowave drives, can be fast. On the other hand, if C is rendered tunable, then a parametric bSWAP is better suited given that detunings between Qᵥ and C are similar and have the same sign. Finally, a ZZ gate could always be enabled by the fast switching on and off of the coupler.

A challenge in the proposed scheme is the requirement of a strong cross-Kerr interaction relative to the coupling strengths between Qᵥ and C. The standard dispersive interactions is not only weak, but also implies weak hybridization with the resonator resulting in virtual interactions in the resonator that are not exponentially suppressed by the protocol. Instead, we introduce a circuit implementation in FIG. 1 b), where the coupler can be made tunable with a flux-pumped SQUID, which we numerically diagonalize, and show the possibility of engineering a strong cross-Kerr interaction between the resonator and C on the order of 10 s of MHz. This interaction is implemented with a three-node loop shared by two large Josephson junctions and an inductance. The Kerr nonlinearity in the resonator is strongly suppressed by shunting the inductance with a capacitor such that it has low impedance. The leading order effect of a small residual Kerr nonlinearity is the renormalization of the displacements in the resonator. Simulations accounting for a residual self-Kerr on the order of 10-100 kHz suggest that results presented in this letter are unchanged. We stress that the efficiency of the protocol is determined by the spatial separation of the coupler’s eigenstates in the resonator, and not on the perfect preparation of specific coherent states. In presence of stronger Kerr nonlinearities in the resonator, stronger drives would yield similar dynamics to those reported in this work. However, stronger drives would slow down the TQD protocol given constraints on the drives amplitude. Moreover, this residual Kerr nonlinearity can be further used as a resource by updating the driving scheme accordingly. Finally we note that the presence of additional off-resonant processes in the circuit would in principle result in renormalizations of the energy spectra of the involved systems, but do not prevent the entanglement of the coupler’s eigenstates to the approximate disjoint states in the cavity. Unlike other architectures where precise fine-tuning of the energy spectra is required for the reduction of specific spurious interactions, the mechanism presented here is not sensitive to these renormalizations, unless they undermine the formation of polaronic states despite stronger drive amplitudes and corrected drive frequencies.

We thus demonstrated an exponential suppression of virtual interactions mediated by a coupler or bus, that interacts with a driven resonator in a way such as to project its eigenstates to polaronic states on demand. The device presented here can be also perceived as a switch, with the perspective of protecting the information stored in qubits that are not being operated on during quantum simulations. Importantly, the device can be used in the context of all-microwave-frequency-fixed architectures as a bus with voltage-tunable coupling operators with closely packed qubit frequencies. While enabling potentially fast two-qubit gates, wavefunction delocalization and multiqubit spurious interactions such as the ZZ error can be suppressed during idle times such as to help reduce qubit errors and chaotic behaviors in quantum processors. We highlight the novelty of the physical mechanism behind the on-demand decoupling, which can be potentially improved with the addition of nonlinearity in the cavity and proper driving scheme to protect the low-lying polaronic states, and cavity squeezing to reduce the overlaps of the cavity states.

Unlike any other proposals, this scheme enables the strong decoupling of the involved quantum systems exponentially with a single voltage drive. It goes beyond reducing the spurious ZZ by suppressing any virtual multiqubit interaction. This new coupler mechanism could help mitigate detrimental many-body dynamics in multiqubit devices.

We stress that the proposed device is not restricted to superconducting circuits, and could be implemented in other platforms. The decoupling mechanism is based on an effective longitudinal interaction, which naturally arises with spin qubits and in the context of optomechanics.

### Alternate Circuit Embodiments

It will be noted that the proposed circuit interestingly provides more specifically a cross-Kerr-type interaction, and more specifically a in situ cross-Kerr-type interaction, which can be additionally interesting because it is not dispersive. Indeed, it was found that superconducting circuits can be provided which enable in-situ and synthetic longitudinal interactions.

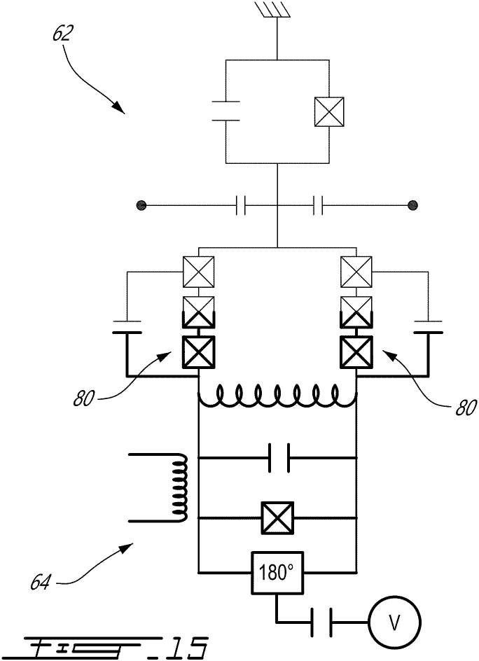

FIGS. 14a) to 14f) illustrate example lumped-element superconducting circuit implementations of the proposed models, with FIG. 14e) presenting an embodiment similar to the embodiment presented in FIG. 9, and FIGS. 14a-d and f) presenting alternate embodiments.

In all the proposed designs a)-f) of FIG. 14, a three-node superconducting loop involving two Josephson junctions 60 in parallel, and an inductance, is present. This loop implements the large cross-Kerr interaction, between the coupler 62 (encoded in the red part of the circuits) and the auxiliary system 64 (encoded in the blue part).

The phase difference across the inductance is associated with the auxiliary system normal mode. The phase difference across the two junctions corresponds to the sum or the different of the branch phases associated with the coupler and the auxiliary system.

The voltage drive in the auxiliary system is implemented with a voltage source 66.

The embodiments presented in FIGS. 14 b), d) and f) are variants respectively to the embodiments presented in FIGS. 14 a), c) and e) in that they additionally use a junction array 68 in parallel with the inductance. This junction array 68 can be used to 1) support a parametric drive in the auxiliary system and 2) tune the self-Kerr anharmonicity in the auxiliary system. The blue coil 70 in b), d), f) is used to flux-biais the inductive loops: the 3-node loop and the loop associated with the auxiliary system. By choosing the areas of these loops, it is possible to assign different flux biases in these loops, independently. These flux biases are used to 1) change the sign of the cross-Kerr interaction, 2) reduce the self-Kerr in the auxiliary system, and 2) generate a parametric drive in the auxiliary system. A parametric drive in b), d) and f) can be implemented with a AC current in the blue coil 70 to generate a flux modulation.

The junctions 60 in parallel to the inductance can be used to engineer the Kerr nonlinearity. The linear drive can also enable a parametric drive in the cavity. It is also possible to use a two-tone drive to enable both linear and parametric drives. It is also possible to use a flux bias in the loop.

In a) and b) the coupler 62 is shown as a LC resonator 72. In c) and d), the coupler 62 is a frequency-fixed transmon 74. In e) and f), the coupler 62 is a tunable Transmon 76. It is assumed that the coupler 62 can take any other suitable form, depending on the ultimate embodiment, such as inductively shunted trasmons and another type of generalized flux qubits for instance.

### Alternate Model

An alternate model referred to herein as displaced inductively shunted Transmon will now be presented in accordance with an embodiment.

This model still strives to entangle the coupler’s eigenstates to distinct coherent states. The efficiency of the protocol depends on how strongly we energetically constrain the auxiliary system to these coherent states. To improve the performance of the protocol, we consequently introduce an anharmonicity of the energy spectrum of the auxiliary system. This anaharmonicity effectively truncate the infinite Hilbert space of the auxiliary system.

Another way of interpreting the following scheme, is that each coupler’s eigenstate is coupled to a displaced version of the same inductively shunted (or L-shunted) Transmon-like qubit, usually approximated by a Kerr oscillator model. The groundstate of the displaced L-shunted Transmon is a coherent state.

The inductive shunt on the Transmon qubit is essential to break the periodicity of the potential energy of the Transmon, given by a cosine potential. This guarantees that the ground-state of the displaced Transmon will indeed be a coherent state.

We focus on the stabilization Hamiltonian of the coupler and auxiliary system shown in FIG. 15. We consider a modulated magnetic flux threading the large inductive loop. Given that there are K Josephson junctions 80 of energy

$${E}_{J a}$$

on each side of the loop (only 3 junctions 80 are shown in FIG. 15), we find the following interaction Hamiltonian [00150]

$${H}_{I} = K {E}_{J o} cos \left(\frac{ϕ}{2 K}\right) cos \left(\frac{φ - \tilde{φ} \left(t\right)}{2 K}\right) ,$$

where ϕ is the branch phase associated with the coupler 62 highlighted in red, and φ is the branch phase associated with the auxiliary system highlighted in blue 64. Here φ(t) is the modulated external phase proportional to the modulated flux through the loop. We do a Taylor expansion in the variable ϕ, φ they have small amplitude. We also consider ^{K} to be sufficiently large such that cos(φ/2K) ≈ 1 and sin(φ/2K) ≈φ/2K We obtain the approximate form [00152]

$${H}_{I} \approx \frac{{E}_{J o}}{∈ 4 {K}^{3}} {ϕ}^{2} {φ}^{2} - \frac{{E}_{J c}}{8 {K}^{2}} \tilde{φ} \left(t\right) {ϕ}^{2} φ ,$$

up to a constant term.

Given the other contributions to the total Hamiltonian from all the circuit elements shown in FIG. 15, we find that ϕ (in red) is subject to a Transmon Hamiltonian (with its characteristic cosine potential) such that such that ϕ² is proportional to the number of excitations in the coupler. Focusing only on φ mode (in blue), we obtain the effective reduced Hamiltonian [00155]

$${H}_{u n r e a d a b l e} \approx 4 {E}_{c} {N}^{2} + 2 e V \left(t\right) N - {E}_{J} cos φ + \frac{{E}_{L}}{2} {\left(φ - n a \left(t\right)\right)}^{2} - \frac{{m}^{2} {n}^{2} \left(t\right) {E}_{L}}{z} + G n {φ}^{2} ,$$

where n is the number of excitations in the coupler (associated with its nth eigenstate),

$$G α {E}_{J c / {E}^{s}}$$

will set the strength of a cross-Kerr interaction between the coupler and the auxiliary system,

$$a \left(t\right) α \tilde{φ} \left(t\right) {E}_{J c} / {K}^{3} {E}_{L}$$

will control the amplitudes of the coherent states. E_{c} is the capacitive energy of the auxiliary system, Eₗ the Josephson energy of its single junction, and E_{L} the inductive energy. V(t) is a voltage drive which will help cancel non-adiabatic errors and grow the coherent states.

We apply a time-dependent transformation on φ such that φ → φ + nα(t). We choose V(t) such as to cancel all linear contributions in the transformed Hamiltonian including terms proportional to a following the Shrödinger equation. Keeping only energetically relevant contributions for the concept we find the approximate Hamiltonian [00158]

$${H}_{n}^{D} \approx 4 {E}_{C} {N}^{2} - {E}_{J} cos \left(n a \left(t\right)\right) cos φ + \frac{{E}_{L}}{2} {φ}^{2} .$$

This exactly corresponds to an inductively shunted Transmon with inductive energy E_{L}, capacitive energy E_{c} and a now time-dependent Josephson energy Eₗcos(na(t)).

If

$${H}_{R}^{D}$$

energetically constrains φ to the vacuum state, then this means that the untransformed system Hₙ is instead constrained in the coherent state |βₙ(t)) where βₙ α

$$n a \left(t\right) / \sqrt{n z}$$

with nz being the reduced impedance of φ. If the latter has a small impedance (small zero-point fluctuations, consistent with previous approximations) one can achieve large displacements despite small flux modulations.

If α(t) is a sine function with a high frequency, we further approximate [00162]

$${H}_{n}^{D} \approx 4 {E}_{C} {N}^{2} - {E}_{J} {J}_{0} \left(n \overline{a}\right) cos φ + \frac{{E}_{L}}{2} {φ}^{2} ,$$

where α is the time-averaged a(t) and l₀(x) is the zeroth Bessel function.

The L-shunted transmon described by

$${H}_{w}^{D}$$

has an anharmonicity renormalized by the zeroth Bessel function.

With the potentially strong anharmonicity of the displaced inductively shunted Transmon, it is possible to energetically protect the entanglement of the coupler’s eigenstates with distinct coherent states such as to potentially improve the efficiency of the proposed scheme.

As can be understood, the examples described above and illustrated are intended to be exemplary only. For instance, a quantum system such as presented herein can be used in different applications. In one application, the quantum system can be a routing system, having a waveguide/transmission line connected to the coupler, the system acting as a single-photon switch. In another application, the quantum system can be embodied as a gate-based quantum computer, such as a cross-resonance frequency-fixed architecture showing small detunings, parametric couplers architectures, and frequency-tunable qubits architectures which can use dynamical decoupling and be implemented with longitudinal drive. Although it was demonstrated above that circuits such as presented in FIGS. 14 and 15 using a three-node superconducting loop involving two Josephson junctions in parallel, and an inductance, can be useful in controlling a coupler in a quantum system, it will be understood that in alternate embodiments, it can be harnessed instead to enable strong longitudinal interactions for readout. Although one embodiment is presented herein embodied in a superconducting architecture, it will be understood that alternate embodiments can be embodied in other architectures, such as photonic circuits, spin-based, trapped ions, cold atoms, semiconducting, and hybrid architectures, such as hybrid photonic circuits. The scope is indicated by the appended claims.

What is claimed is:

1. A quantum system comprising :
a first quantum subsystem having a first set of eigenstates;
a second quantum subsystem having a second set of eigenstates;
a coupler connected to both the first quantum system and to the second quantum system, the coupler having a third set of eigenstates;
at least one interaction drive associated to a respective one of the first quantum subsystem, the second quantum subsystem and the coupler, the at least one interaction drive configured to control interaction between the first set of eigenstates and the second set of eigenstates via transitions within the third set of eigenstates;
an auxiliary quantum subsystem connected to the coupler; and
an attenuation drive selectively operable at a drive amplitude to generate a set of stabilized states in the auxiliary quantum system, said set of stabilized states being entangled with the third set of eigenstates.

2. The quantum system of claim 1 wherein the set of stabilized states are entangled with the third set of eigenstates in a manner that the probability of said transition within the third set of eigenstates is set by a probability of transition in the set of stabilized states, said probability of transition in the set of stabilized states being reduced exponentially as a function of an increase in drive amplitude.

3. The quantum system of claim 1, wherein the auxiliary quantum subsystem is a first auxiliary quantum subsystem, the attenuation drive is at least one attenuation drive, the set of stabilized states is a first set of stabilized states, further comprising :
a second auxiliary quantum subsystem connected to at least one of the coupler and the first auxiliary quantum subsystem;
wherein the at least one attenuation drive further generates a second set of stabilized states in the second auxiliary quantum system, said second set of stabilized states being entangled with the first set of stabilized states and the third set of eigenstates in a manner that the probability of said transition in the third set of eigenstates is further set by a probability of transition in the second set of stabilized states, said probability of transition in the second set of stabilized states being reduced exponentially as a function of an increase in the drive amplitude.

4. The quantum system of claim 1 provided in the form of a superconducting circuit, wherein the auxiliary quantum subsystem and coupler are embodied as a circuit element having a three-node superconducting loop involving two Josephson junctions in parallel, and an inductance.

5. A method of operating a quantum system comprising :
using an interaction drive, controlling the eigenstates of at least one a first quantum subsystem, a second quantum subsystem, and a coupler, to stimulate a quantum interaction between the first quantum subsystem and the second quantum subsystem; and, subsequently
using an attenuation drive, generating a set of stabilized states in an auxiliary quantum subsystem, and entangling the set of stabilized states of the auxiliary quantum subsystems with the eigenstates of the coupler to impede quantum interactions between the first and second quantum subsystems via the coupler.
